(19) United States
(12) Patent Application Publication
(10) Pub. No.: US 2011/0188693 A1
(43) Pub. Date: Aug. 4, 2011

(54) Receiving Set for Individual

(75) Inventor: Byoung-Wha Kim, Gyeongsangnam-do (KR)

(73) Assignee: Byoung Wha Kim

(21) Appl. No.: 12/992,200

(22) PCT Filed: Nov. 9, 2009
(86) PCT No.: PCT/KR09/06551

§ 371 Date: Jan. 27, 2011

(30) Foreign Application Priority Data
Nov. 10, 2008 (KR) 10-2008-0111131
Nov. 10, 2008 (KR) 10-2008-0111155
Dec. 19, 2008 (KR) 10-2008-0130288
Dec. 19, 2008 (KR) 10-2008-0130297

(51) Int. Cl. H04R 1/02

(52) U.S. Cl. 381/334

(57) ABSTRACT

The present invention relates to a receiving set for individual, and more particularly, to a receiving set for individual in which the exposure of line is minimized not to interrupt the user's face and both hands so that the convenience of use and the user's activity can be improved and the speakers transferring sound signals are distanced from the user's auditory organ and supported to be possible to change their positions to allow the user listening to sounds with his auditory organ open.

The receiving set for individual comprises a first unit placed on the user's head portion; and second units supported by the first unit and disposing the speakers to be distanced from the user's auditory organ. According to the receiving set for individual having such composition, since there is no line interrupting the user's face or both arms, the user can freely move, so the user's activity can be secured. Therefore, when the users use the receiving sets while they enjoy their hobbies or outdoor activities, the convenience of use is improved, the safety is considerably improved, and the user's activity can be secured.

### BACKGROUND OF THE INVENTION

1. Field of the Invention

The present invention relates to a receiving set for individual and more particularly, a receiving set for individual for listening to sounds with minimizing the exposure of lines and user's auditory organ being open.

2. Description of the Related Art

The receiving set is a device for transferring sounds from sound systems generating sounds such as radios, MP3 players, or Bluetooth-enabled devices so that the users can listen to the sounds. Such receiving sets are called earphones, headsets, etc. and they are used in the way being inserted in the user's auditory organ, ears or covering the user's auditory organ to shut off sound information from outside and better transfer the sound from sound systems to users.

When the user listens to sounds transferred from a sound system with shutting off sound information from outside as above, the user cannot perceive sounds generated outside the user when the user does outdoor or indoor activities and this can increase the risk of sudden accidents.

In addition, since the user listen to sounds with covering his auditory organ, communication with others becomes difficult and such communication rupture decreases the user's sociality, so that the user's individualistic tendency increases and conversation ability decreases.

Further, general receiving sets in a type of covering user's auditory organ have long connecting lines for transferring sounds generated from sound systems. Accordingly, the long connecting lines exposed to the outside lead from the users' ears to sounds systems kept in the users' cloths or bags and these lines inconveniently interrupt the movements of users' hands or bodies.

Since the users' movements are restricted like this, it becomes difficult for users to deal with sudden situations with agility to more increase the risk of accidents.

Besides, since the long exposed connecting lines have a tendency of being easily entangled, they should be untangled or used entangled when used and when untangling them, troubles such as poor connection of contact point of connecting lines can frequently occur.

In addition, since general receiving sets covering the users' auditory organs directly transfer sounds to the auditory organs in an enclosed space, this can inconveniently irritate the users' ears and damage users' hearings when they use such devices for a long time. Accordingly, there is also a problem that the users are always worried about their health whenever they use such receiving sets.

That is, since such receiving sets are inserted into the users' auditory organs and directly transfer sounds to the auditory organs, it can cause the inflammation and eardrum damage of the external auditory meatus, the ear trouble and hearing problems due to a burden on the vestibular organ of the internal auditory meatus, and dizziness due to the long time of listening.

On the other hand, recently, many people wear accessories such as hats when they go out for their hobbies such as climbing or fishing for the reason of health in order to block direct sunlight and ultraviolet rays and to prevent their facial skins from aging, burn, etc. and protect their eyes from strong ultraviolet rays due to the damage in the ozone layer. Accordingly, there is an inconvenience that users must separately prepare such accessories and sound systems for listening to sounds that users want.

In addition, since the connecting lines connecting the sound systems and the receiving sets for listening to sounds are generally exposed outside, there can be problems that they cannot be in harmony with various accessories that users wear or it can be difficult to use the receiving sets due to the various accessories.

Further, since it is difficult to variously use the receiving sets and use the same in various places, users should prepare various receiving sets according to the uses and places. Since users should additionally buy receiving sets and accessories such as hats as above, it may cause the economical burden for users.

### DETAILED DESCRIPTION OF INVENTION

### Technical Objects

The object of the present invention is to provide a receiving set for individual formed for minimizing the line exposure to outside.

The another object of the present invention is to provide a receiving set allowing listening to sounds with user's auditory organ being open.

### Technical Solution

A receiving set according to the present invention comprises a first unit placed on user's head; and second units supported by the first unit and positioning speakers distanced from the user's auditory organ.

In addition, a receiving set according to the present invention comprises a first portion placed on user's head; second portions extended from the first portion toward user's auditory organ, supported by the first portion possibly to change their positions, and positioning speakers transferring sounds in places where the user's auditory organ can be open to outside sounds; and a third portion at least supporting the first portion and that the user puts on his head.

Further, a receiving set according to the present invention comprises a first member having its own elasticity; second members extended from the first member toward user's auditory organ; a third member at least supporting the first member and that the user puts on his head; a fourth member supported by the second member and positioning portions of speakers from which sounds come out to face toward the user's auditory organ and be distanced from the auditory organ; and a connecting line for transferring provided sounds to the speakers, a part of the line being held by the first member and another part by the fourth member.

### Advantageous Effectiveness of Invention

According to the receiving set for individual of the present invention, the length of line transferring sounds to speakers is minimized and the line exposed to outside is minimized.

Minimizing the length of line connected with the sound system providing sounds and the portion of line exposed to outside like this makes the user's movement free because there is no line interrupting the user's face and arms and since this guarantees user's activity, the convenience of use can be improved when users use the receiving sets while enjoying their hobbies or outdoor activities.

In addition, since the receiving sets according to the present invention has an advantage that it can satisfy the users' demands that they want to conveniently use the receiving sets while enjoying their hobbies or outdoor activities and the users' movements become free, the users can handle sudden changes of external situations. Accordingly, it is possible for the users to handle sudden accidents, so the effect of preventing accidents can be expected and this means that using the receiving set according to the present invention has an effect to considerably increase the safety.

Further, minimizing the length of line transferring sounds to the speakers has an effect to decrease the electric resistance by the connecting line and the decrease of the electric resistance has advantages to allow transferring sounds of better quality to the speakers and reducing the electric power consumption to increase the using time of sound system.

Furthermore, the receiving set for individual according to the present invention can maximize the convenience for users because the users can appropriately use the same sets in response to situations and places.

On the other hand, according to the receiving set for individual of the present invention, the user can listen to sounds with his auditory organ open, so sounds do not directly irritate the user's auditory organ and the user's hearing damage can be prevented. Accordingly, the receiving set of the present invention has an advantage that the user can listen to sounds with only a few worries about his health using the same.

### BRIEF DESCRIPTION OF THE DRAWINGS

FIG. 1 is a perspective view showing a receiving set for individual according to a first embodiment of the present invention;

FIG. 2 is a perspective view showing another form of the receiving set for individual according to the first embodiment of the present invention;

FIG. 3 is a perspective view showing another form of the receiving set for individual according to the first embodiment of the present invention;

FIG. 4 is a perspective view showing the composition of the decomposed receiving set for individual according to the first embodiment of the present invention;

FIG. 5 is a perspective view showing another form of the receiving set for individual according to the first embodiment of the present invention;

FIG. 6 is a perspective view showing another form of the receiving set for individual according to the first embodiment of the present invention;

FIG. 7 is a perspective view showing another form of the receiving set for individual according to the first embodiment of the present invention;

FIG. 8 is a perspective view showing another form of the receiving set for individual according to the first embodiment of the present invention;

FIG. 9 is a perspective view showing another form of the receiving set for individual according to the first embodiment of the present invention;

FIG. 10 is a perspective view showing a receiving set for individual according to a second embodiment of the present invention;

FIG. 11 is a bottom view showing the receiving set for individual according to the second embodiment of the present invention;

FIG. 12 is a perspective view showing the receiving set for individual according to the second embodiment of the present invention from which the sound system is removed;

FIG. 13 is a sectional view of the receiving set for individual in FIG. 11 sectioned along the line I-I′;

FIG. 14 is a perspective view showing another form of the receiving set for individual according to the second embodiment of the present invention;

FIG. 15 is a perspective view showing another form of the receiving set for individual according to the second embodiment of the present invention;

FIG. 16 is a perspective view showing another form of the receiving set for individual according to the second embodiment of the present invention;

FIG. 17 is a perspective view showing another form of the receiving set for individual according to the second embodiment of the present invention;

FIG. 18 is a perspective view showing another form of the receiving set for individual according to the second embodiment of the present invention;

FIG. 19 is a perspective view showing another form of the receiving set for individual according to the second embodiment of the present invention;

FIG. 20 is a perspective view showing another form of the receiving set for individual according to the second embodiment of the present invention; and

FIG. 21 is a perspective view showing another form of the receiving set for individual according to the second embodiment of the present invention.

### EMBODIMENTS OF THE INVENTION

Exemplary embodiments of the present invention will now be described in detail through the accompanying drawings. However, the present invention will be described through exemplary embodiments only for convenience for description, and the spirit of the present invention will not be limited by the above-mentioned embodiments; persons of ordinary skill in the art who understand the spirit of the present invention can additionally propose another embodiments which are involved in the spirit and scope of the present invention or other retrogressive invention through addition, modification, deletion, etc. of other constituents, but these are also involved in the spirit of the present invention.

In addition, terms used in this specification or claims are selected for convenience for description, so they should properly be interpreted as meanings corresponding to the spirit of the art according to the present invention.

### First Embodiment

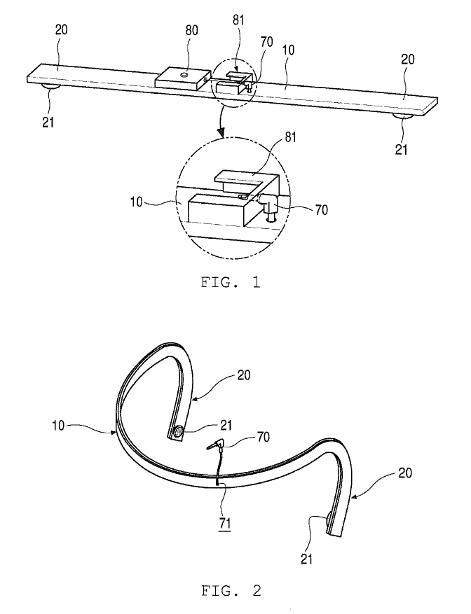

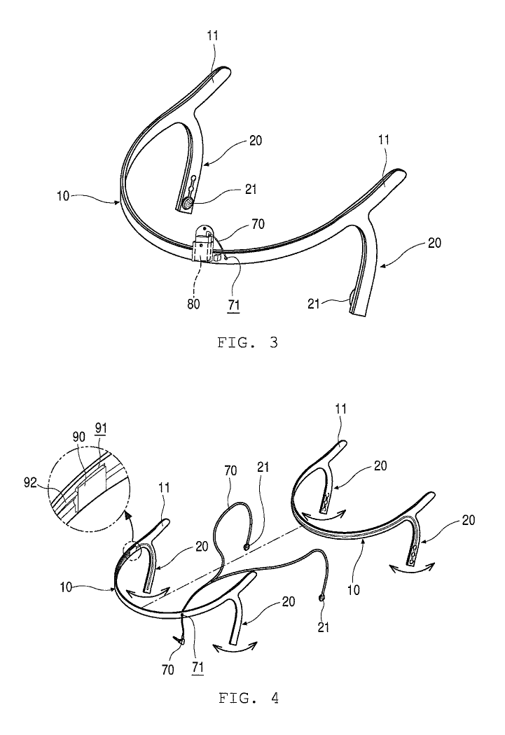

The receiving set for individual according to the first embodiment of the present invention will be described below making reference to FIG. 1 to FIG. 9. In FIG. 1, a perspective view of a receiving set for individual according to the first embodiment of the present invention is illustrated and in FIG. 2, a perspective view of another form of the receiving set for individual according to the first embodiment of the present invention is illustrated.

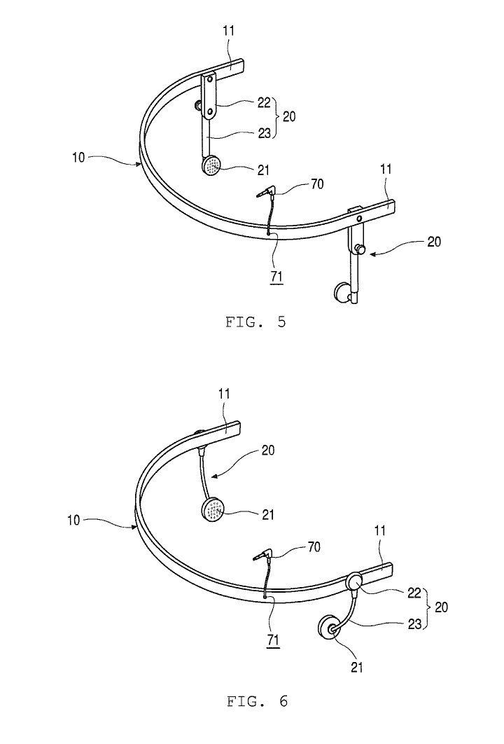

In addition, FIG. 3 illustrates a perspective view showing another form of the receiving set for individual according to the first embodiment of the present invention, and FIG. 4 illustrates a perspective view showing the composition of the decomposed receiving set for individual according to the first embodiment of the present invention.

The receiving set for individual according to the present invention comprises a first unit placed on user's head portion; and second units supported by the first unit and positioning speakers distanced from the user's auditory organ.

Referring to FIG. 1 and FIG. 2 where the first unit 10 and the second units 20 are formed in monolithic structure, the first unit 10 has a certain inner space and a form of rectangular parallelepiped long in horizontal direction and the second units 20 are positioned at both end portions of the first unit 10. The second units 20 have a certain inner space extended from the first unit 10 and their positions are changeable in comparison with the first unit 10.

More particularly, the second units 20 extended from both end portions of the first unit 10 can be moved in any directions up, down, left, right in comparison with the first unit 10.

That is, referring to FIG. 1, the first unit 10 is made of a material having a certain elasticity of its own and has a space inside, the second units 20 are formed at both end portions of the first unit 10 to be possible to change their positions, and when the second units 20 are extended in horizontal direction from the portions from which the second units 20 begins to be extended from the first unit 10, the entire form that the first unit 10 and the second units make looks like “-” shape.

In addition, referring to FIG. 2, when both end portions of the first unit 10 are positioned in the rear so that the first unit 10 has a certain curvature, the first unit 10 generally has a form of “U” seen from the top.

Here, when the second units 20 are downwardly moved in comparison with the first unit 10, the first unit 10 and the second units 20 generally form “ [symbol] ” shape seen from the right.

The first unit 10 and the second units 20 can be formed to be possible to open their inner space or to be impossible to open the same. If the inner space can be opened, the present invention has an advantage to easily replace or repair numerous components placed in the inner space.

When the inner space of the first unit 10 and the second units 20 cannot be opened, it is possible to form a groove in which the connecting line connected with the sound system for providing sounds can be kept or protrusions to support the connecting line between which the connecting line is inserted.

On the other hand, the second units 20 are formed possible to support at least some parts of speakers 21 transferring sounds provided to the user's auditory organ in form of audio signals. The speakers 21 are respectively positioned at the end portions of the second units 20 and since the second units 20 is possible to move their positions in comparison with the first unit 10, the speakers 21 at least whose parts are kept in the second units 20 can also move their positions in response to the position change of the second units 20.

Since it is possible to change the positions of speakers 21, the users can choose the positions of speakers 21, so the users can position the speakers in a proper position depending on their preferences and physiques to listen to desired sounds. This means that the convenience for users is advantageously improved.

In one portion of the first unit 10, a sound system supporting portion 81 for supporting the sound system 80 generating sounds that the user want and providing the same to the speaker 21 can be further prepared. The sound system 80 is a device for generating sounds that the user want and transferring to the speaker 21. For example, MP3 players, FM/AM radios, Bluetooth-enabled devices, etc. can be mentioned.

The sound system supporting portion 81 can be integrated with a portion of the first unit 10 or can be formed to be detachable from the first unit 10. That is, the same can be formed by being protruded from the first unit 10 to the outside to support the sound system 80 by holding a part of the sound system 80 or can be formed to be possible to detach a portion by which at least a part of the sound system 80 is held from the first unit 10 to support the sound system 80.

Here, the connecting line 70 connected to the speakers 21 can be exposed to outside in a portion of the first unit 10 to be connected with the sound system 80 or be fixed to the sound system supporting portion 81 in a form of jack. In the latter case, the sound system 80 is connected with the jack by being fixed in the sound system supporting portion 81 and the connecting line 70 is connected with the sound system 80 by being connected with the jack.

When the second units 20 change their positions backwardly and downwardly in comparison with the first unit 10, the positions of the speakers 21 at least some parts of which are supported by the second units 20 are changed. Even when the positions of the speakers 21 are changed like this, it is preferable that portions of the speakers 21 from which sound signals come out face to each other, so that desired sounds are directed toward the user's auditory organ.

Another form of the receiving set for individual according to the first embodiment of the present invention will be described below making reference to FIG. 3 and FIG. 4.

The first unit 10 is bent in horizontal direction so that its center portion has a certain curvature toward the front direction and both end portions are positioned in the rear in comparison with the center portion and the second units 20 are positioned lower than the first unit 10 so that the portions where the speakers 21 are positioned can be extended from the first unit 10 toward the user's auditory organ.

In addition, the first unit 10 further comprises extensions 11 extended in horizontal direction of the first unit 10 from portions where the second units 20 begin to be downwardly bent. The extensions 11 is integrated with the first unit 10 and continue from the end portions of the first unit 10 toward the directions to which both end portions of the first unit 10 are directed.

The extensions 11 function as fixing means so that the first unit 10 does not leave the user's head when the same is positioned on the user's head portion.

Here, the first unit 10 comprises the detachable sound system supporting portion 81 for supporting the sound system 80, on one side of the sound system supporting portion 81, a hole for connecting line 71 to expose the connecting line 70 to the outside of the first unit 10 so that the connecting line 70 can be connected with the sound system 80. The description about this follows.

The connecting line 70 is exposed to the outside of the first unit 10 through the hole for connecting line 71 and joined to the sound system 80 to transfer sounds generated from the sound system 80 to the speaker 21.

It is also certainly possible that the sound system supporting portion 81 is integrated with the first unit 10 and the connecting line 70 is fixed to the sound system supporting portion 81. In this case, when the sound system 80 is connected with the connecting line 70 with being supported by the sound system supporting portion 81.

Hereinafter, the composition of the receiving set for individual according to the present invention having a form in FIG. 3 is described making reference to FIG. 4. FIG. 4 is a sectional perspective view showing the composition of the receiving set for individual according to the present invention having a form in FIG. 3.

First, in case that the first unit 10, the second units 20, and the extensions 11 are integrated, the entire device comprising the first unit 10, the second units 20, and the extensions 11 is divided into a fore half portion and a rear half portion and the connecting line and at least some portions of the speakers 21 are placed inbetween.

The connecting line 70 has a circular shaped cross section of a certain diameter. Its one end portion having a form of jack passes through the hole for connecting line 71, is exposed to the outside of the first unit 10, and is joined to the sound system 80 and its other end portion is connected with the speakers 21 to transfer the sounds generated from the sound system 80 to the speakers 21.

The connecting line 70 supported by the first unit 10 is divided into left and right parts and those are directed toward the second units 20 with being supported by the first unit 10 and are connected with the speakers 21 at least some portions of which are supported by the second units 20.

Like this, one end portion of the connecting line 70 is exposed to the outside of the first unit 10 and connected with the sound system 80 and its other end portion is connected with the speakers 21 with being supported by the first unit 10 and the second units 20 and transfers sounds provided from the sound system 80 to the speakers 21.

Here as well, the second units 20 are supported by the first unit 10 to be possible to change their positions in comparison with the first unit 10 so that the speakers 21 can change their positions by changing the second units' 20 positions.

The first unit 10, second units 20, and extensions 11 can be formed to allow opening their inside as shown in FIG. 4 or integrated not to allow opening their inside. In former case, there is an advantage that the user can open their inside to replace or repair the connecting line 70 or the speakers 21 and in latter case, there are advantages that it is easy to store the set and causes of troubles can be reduced.

Hereinafter, another form of the receiving set for individual according to the first embodiment of the present invention is described making reference to FIG. 5. FIG. 5 is a perspective view showing another form of the receiving set for individual according to the first embodiment of the present invention.

Referring to FIG. 5, the first unit 10 is not integrated with the second units 20, but the separately formed second units 20 are extended toward the user's auditory organ. Here, referring to the connection of the second units 20 with the first unit 10, the second units 20 comprise linking portions 22 connected with the first unit 10 and combining portions 23 joined to the linking portions 22 and possible to change their positions so that the speakers 21 can change their positions.

The linking portions 22 some parts of which are extended from the first unit 10 toward the user's auditory organ can be fixed to the first unit 10 or connected with the first unit 10 to be possible to change their positions.

The combining portions 23 are joined to the linking portions 22 connected with the first unit 10 and at least some parts of the speakers 21 converting sounds transferred from the sound system 80 into sound signals and outputting the same are supported by these combining portions 23.

Since the some parts of the speakers 21 are supported by the combining portions 23, it is possible to change positions of the speakers 21 by changing the positions of the combining portions 23. Since the set is formed to be possible to change the speakers' 21 positions like this, it is advantageous that users can move the speakers 21 in the desired positions to listen to sounds.

For example that the combining portions 23 are joined to the linking portions 22 to be possible to change their positions, the combining portions 23 can be joined to the linking portions 22 by hinges to be rotatable. The combining portions 23 can change their positions in comparison with the linking portions 22 by pivoting on the hinges and accordingly, the speakers 21 at least some parts of which are supported by the combining portions 23 can change their positions.

In addition, as shown in figure, the combining portions can be formed to allow the upwardly and downwardly translational motion to change the speakers' 21 positions. That is, the combining portions 23 are formed to be extended toward the user's auditory organ with forming certain angles with the first unit 10 and the linking portions 22 by the combining portions' 23 pivoting on the hinge by which the combining portions 23 are joined to the linking portions 22.

After having directed the combining portions 23 toward the user's auditory organ, the combining portions 23 by which at least some parts of the speakers 21 are supported do a translational movement to dispose the speakers 21 in the closest positions to the user's auditory organ or in the positions that the user wants. To allow changing the speakers' positions, the combining portions 23 comprise several portions among which the outermost portion 23 has larger sectional area than the portion 23 disposed inside the outermost portion 23 so that the portion 23 having smaller sectional area can be received inside the outermost portion 23.

Such combining portions 23 can be formed in which several combining portions 23 are received inside the outermost portion 23 or only one combining portion 23 is received. Certainly, when several combining portions 23 are kept inside the outermost portions 23, the translational movement up to farther distance can be possible.

Here, it is possible that the linking portions 22 are connected with the first unit 10 to be possible to change their positions. That is, the linking portions 22 can be connected with the first unit 10 to be possible to be guided by the first unit 10 and to do the translational movement or the linking portions 22 can rotatably be connected with the first unit 10.

Hereinafter, another form of the receiving set for individual according to the first embodiment of the present invention is described making reference to FIG. 6. FIG. 6 is a perspective view showing another form of the receiving set for individual according to the first embodiment of the present invention.

Referring to the figure, the second units 20 are connected with the first unit 10 and the second units 20 are formed to have elasticity of their own so that the speakers 21 at least some parts of which are supported by the second units 20 can change their positions.

The second units 20 made of a material having elasticity of its own support the connecting line 70 and at least some parts of the speakers 21 on the opposite portions to the portions connected with the first unit 10 so that the user can move the speakers 21 to the positions that he wants.

The second units 20 can be integrated with the first unit 10 or can comprise linking portions 22 connected with the first unit 10 and combining portions 23 supported by the linking portions 22.

Here as well, the second units 20 can change their positions in comparison with the first unit 10. That is, in case that the second units 20 are integrated with the first unit 10, the second units 20 are formed to allow doing the translational movement along the horizontal direction of the first unit 10. First, the second units 20 are moved near the user's auditory organ and then the portions having elasticity are adjusted to have the speakers 21 in the desired positions, so that the user can listen to sounds having speakers 21 in the proper positions or desired positions.

Since the speakers' 21 positions can be adjusted by the elasticity of the second units 20 for the user to move the speakers' 21 positions to the places that he wants and the second units 20 are connected with the first unit 10 to be possible to change their positions, the user can more minutely adjust the speakers' 21 positions and this advantageously improves the convenience of use of the receiving set.

In addition, it is also possible that the linking portions 22 are connected with the first unit 10 to be possible to rotate or to do the translational movement and the combining portions 23 are supported by the linking portions 22 so that the speakers 21 can be moved to the positions that the user wants by the elasticity of the combining portions 23.

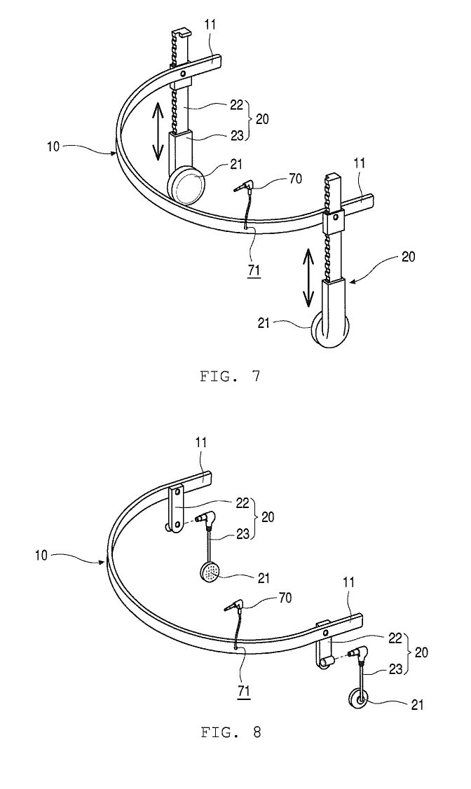

Hereinafter, another form of the receiving set for individual according to the first embodiment of the present invention is described making reference to FIG. 7. FIG. 7 is a perspective view showing another form of the receiving set for individual according to the first embodiment of the present invention.

The second units 20 comprise linking portions 22 connected with the first unit 10 and combining portions 23 guided by the linking portions 22 and allowing the adjustment of the speakers' 21 positions.

The linking portions 22 can be fixed to the first unit 10 or can be connected with the first unit 10 to be possible to change their positions. When changing the positions of the combining portions 23 in both cases, the linking portions 22 guide the movement of the combining portions 23 of course.

First, the linking portions 22 are fixed to the first unit 10, and then guides for guiding the combining portions' 23 movement are formed on one sides of the linking portions 22 and these guides guide the movement of the combining portions 23. For example, the guides can be formed in the form of grooves formed on one sides of the linking portions 22 and the combining portions 23 upwardly and downwardly move with the portions for combining of the combining portions 23 joined to the grooves being guided by the grooves to allow the adjustment of the speakers' 21 positions.

Here, it is possible that the combining portions 23 are joined to the linking portions 22 by numerous protrusions protruded from the combining portions 23 toward the connection portions 22 being caught by the grooves formed on the linking portions 22 or that the linking portions 22 comprise certain spaces inside through which the combining portions 23 pass and in which grooves are formed and the protrusions formed on the combining portions 23 toward the grooves are guided by the grooves so that the combining portions 23 can move along the grooves.

In addition, the linking portions 22 can be connected with the first unit 10 to be possible to change their positions. That is, the linking portions 22 can be connected with the first unit 10 to be possible to do the translational movement along the horizontal direction of the first unit 10 or can be connected with the first unit 10 by hinges to be possible to pivot on the hinges.

As above, in both cases that the linking portions 22 are fixed to the first unit 10 or connected with the first unit 10 to allow changing their positions, the linking portions 22 are joined to the combining portions 23 to be possible to guide the combining portions 23.

When the linking portions 22 are connected with the combining portions 23 to be possible to guide the movement of the combining portions 23, the combining portions 23 can be moved with being guided by the linking portions 22 and this makes the adjustment of the speakers 21 at least some parts of which are supported by the combining portions 23 possible.

In this case, it will be preferable that the linking portions 22 or the combining portions 23 comprise stoppers for restricting the range of movement of the combining portions 23. The stoppers can be formed in the linking portions 22 or the combining portions 23.

Restricting the range of movement of the combining portions 23 by stoppers is to prevent the combining portions 23 from being detached from the linking portions 22 by the movement. That is, when the user excessively moves the combining portions 23, the combining portions 23 can be detached from the first unit 10. Accordingly, to prevent the combining portions 23 from excessively moving, the stoppers are prepared and restrict the range of the movement of the combining portions 23.

In addition, while the linking portions 22 translationally move with being guided along the horizontal direction of the first unit 10, the combining portions 23 translationally move in the intersecting direction with the moving direction of the linking portions 22. They can move in different directions, so that the user can move the speakers 21 to the positions that he wants.

When the linking portions 22 are connected with the first unit 10 to rotate as well, the combining portions 23 can translationally move upwardly and downwardly to allow moving the speakers 21 to the positions that the user wants.

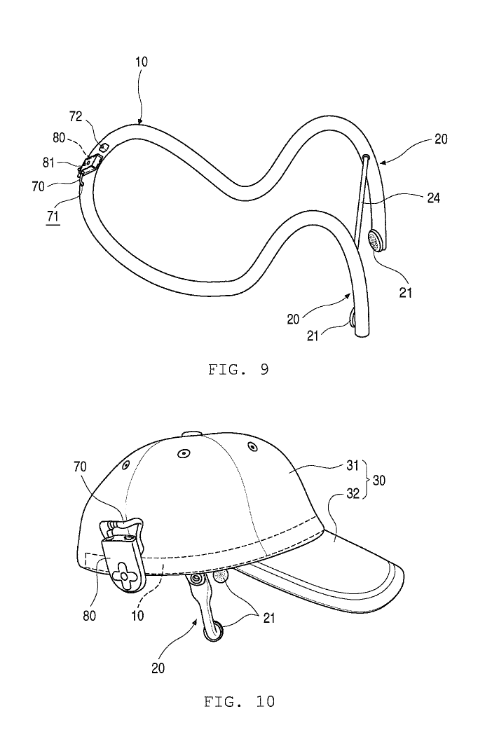

Hereinafter, another form of the receiving set for individual according to the first embodiment of the present invention is described making reference to FIG. 8. FIG. 8 is a perspective view showing another form of the receiving set for individual according to the first embodiment of the present invention.

Referring to the figure, the second units 20 can selectively be attached to the first unit 10. Here, the second units 20 comprise linking portions 22 connected with the first unit 10 and combining portions 23 made of a material having elasticity of its own and formed to be selectively attachable to the linking portions 22.

One portion of the linking portion 22 is connected with the first unit 10 and the other portion is connected with the combining portion 23. That is, one portions of the linking portion 22 is connected with the first unit 10 to be possible to change its position and the other portions is connected with the combining portion 23 and a portion by which the linking portion 22 is connected with the combining portion 23 has a cylinder form of inner space. A portion of the combining portion 23 having a form of jack is inserted into the inner space so that the combining portion 23 is connected with the linking portion 22 and the speaker 21 supported by the combining portion 23 can be positioned in the place that the user wants.

The portion of the combining portion 23 by which the combining portion 23 is connected with the linking portion can have a form of jack or a form of socket connecting electrodes with each other. That is, whatever its form is, the second unit 20 is formed by connecting the linking portion 22 and the combining portion 23 with each other.

Further, the combining portion 23 is made of a material having elasticity of its own so that the speaker 21 at least some part of which is supported by the combining portion 23 can be moved to the position that the user wants. Here, if the linking portions 22 are connected with the first unit 10 to be possible to change their positions, the user can move the linking portions 22 to the desired positions and then can move the speakers 21 to the desired positions by using the elasticity of the combining portions 23.

That is, the linking portions 22 are connected with the first unit 10 to be possible to rotate or translationally move and the combining portions 23 are connected with the linking portions 22 to be detachable so that the user can move the speakers 21 to the positions that he wants.

Like this, thanks to the movement of the linking portions 22 and the combining portions 23 selectively connected with the linking portions 22, the user can advantageously position the speakers 21 in the places that he wants to listen to the sounds.

Hereinafter, another form of the receiving set for individual according to the first embodiment of the present invention is described making reference to FIG. 9. FIG. 9 is a perspective view showing another form of the receiving set for individual according to the first embodiment of the present invention.

Referring to the case that the first unit 10 is integrated with the second units 20 making reference to the attached drawing, the first unit 10 having a certain elasticity comprises a certain inner space and the second units 20 extended from both end portions of the first unit 10.

Here, the first unit 10 and the second units 20 have a cylindrical form whose cross section has a certain diameter. The speakers 21 are supported by the second units 20 and a connecting portion 24 having a certain elasticity is prepared between one end portion of the first unit 10 and the other end portion of the first unit 10.

The connecting portion 24 is made of a material having a certain elasticity and its both end portions are fixed to the second units 20 and this provides fixing force to prevent the first unit 10 from being detached from the user's head when the first unit 10 is positioned on the user's head portion.

The first unit 10 can provide a certain fixing force of course by its own elasticity, and the connecting portion 24 further provides fixing force. The connecting portion 24 can provide fixing force by its both end portions being respectively connected with two end portions of the first unit 10 and using its own elasticity, by its both end portions being fixed and its center portions being combined with each other, or its one end portion being fixed to the first unit 10 and the other end portion being coupled to a coupling member prepared on the first unit 10.

Since the fixing force is provided by the connecting portion 24 like this, when the user place the first unit 10 on his head portion, the first unit 10 can be fixed to the user's head portion.

Further, in case that the first unit 10 comprises the extensions 11, the connecting portion 24 is placed between the extensions 11 and when the user place the first unit 10 on his head portion, the connecting portion 24 provides fixing force so that the first unit 10 and the second units 20 are not easily detached from the user's head by the elasticity of the connecting portion 24.

On the other hand, referring to FIG. 4, the first unit 10 and the second units 20 comprise an application apparatus supporting portion 91 for holding an application apparatus 90 for supplementary functions of the receiving set in their inner space. The application apparatus 90 is to add convenient functions to the receiving set.

For example of the application apparatus 90, Bluetooth, communication apparatus, amplifier, transmitter-receiver, lighting device (LED lamp), radio antenna line, etc. can be mentioned. When such application apparatuses 90 supported by the application apparatus supporting portion 91 are prepared, it will be possible for user to listen to desired sounds, communicate with others, or listen to sound signals converted from separately inputted frequencies or signals.

To use the receiving set for individual with using the application apparatus 90 like this, it is possible that the first unit 10 and the second units 20 further comprise application apparatus line. The application apparatus line 92 is for connecting the application apparatus 90 with the speakers 21 or with the power to listen to sound signals by using the application apparatus 90 or to make the receiving set perform other functions.

### Second Embodiment

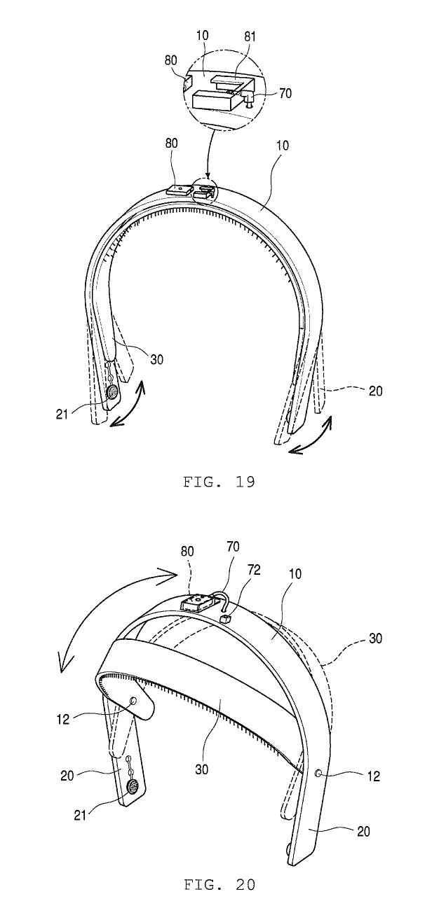

The receiving set for individual according to the second embodiment of the present invention will be described below making reference to FIG. 10 to FIG. 21. Here, the first unit 10 having the same composition with the above will be mentioned as the first portion and the second units 20 as the second portions and the same reference numerals will be used.

FIG. 10 is a perspective view showing the appearance of the receiving set for individual according to the second embodiment of the present invention and FIG. 11 is a bottom view showing the bottom of the receiving set for individual according to the second embodiment of the present invention.

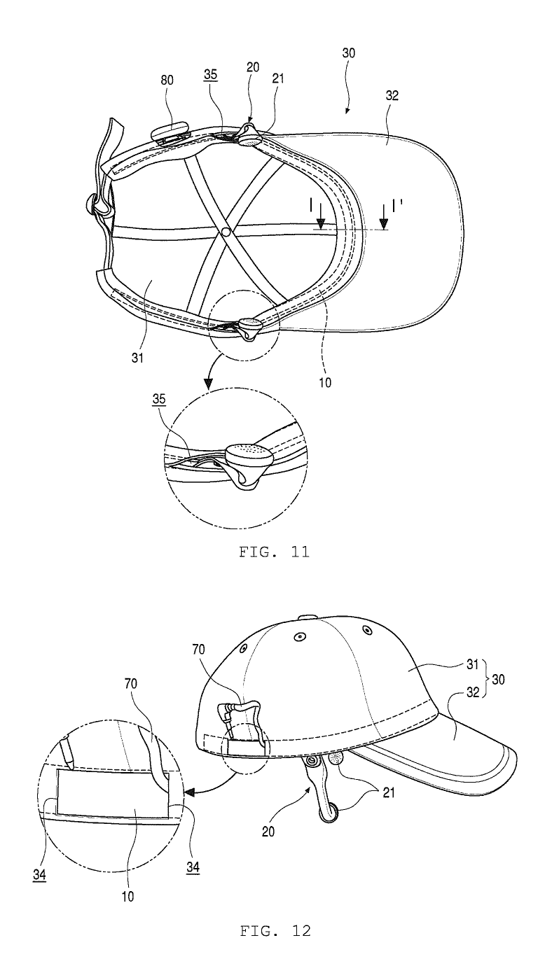

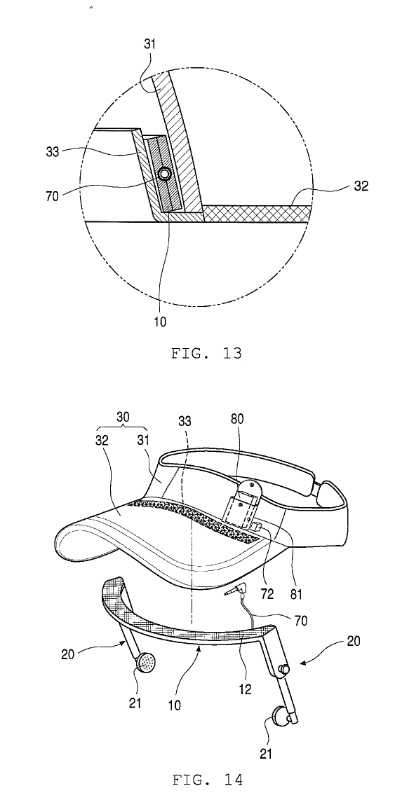

In addition, FIG. 12 is a perspective view showing the receiving set for individual according to the second embodiment of the present invention from which the sound system is removed and FIG. 13 is a partial sectional view showing the inner structure of the receiving set for individual according to the second embodiment of the present invention.

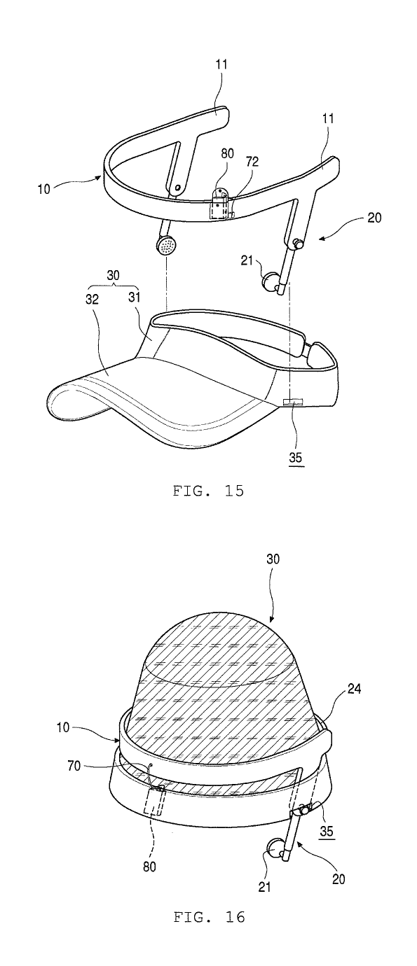

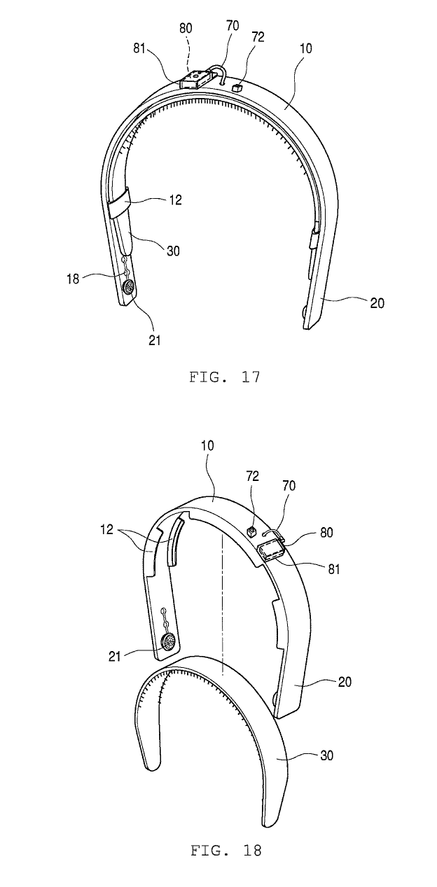

FIG. 14 is a perspective view showing another form of the receiving set for individual according to the second embodiment of the present invention, FIG. 15 is a perspective view showing another form of the receiving set for individual according to the second embodiment of the present invention, and FIG. 16 is a perspective view showing another form of the receiving set for individual according to the second embodiment of the present invention.

Making reference to the attached drawings, the receiving set for individual according to the second embodiment of the present invention comprises a first portion 10 placed on the user's head portion, a second portions 20 extended from the first portion 10 toward the user's auditory organ, supported by the first portion 10, and positioning speakers in the places where the user's auditory organ can be open to outside sounds, and a third portion 30 at least supporting the first portion 10 and positioned on the user's head portion.

The third portion 30 comprises a wearing portion 31. The wearing portion 31 can be positioned on the user's head portion with covering the user's head portion or the user's head is just fitted into the wearing portion 31 without being covered by the wearing portion 31.

That is, the wearing portion 31 can be put on the user's head portion with covering the user's head portion or the user's head can be fitted into the wearing portion 31 having a certain solidity and elasticity.

In case that the wearing portion 31 is put on the user's head portion with covering the user's head portion, the wearing portion 31 comprises an outer portion having a certain thickness and an inner space to have a hemisphere form and the user can put on the wearing portion 31 by the user's head being received by the inner space.

In case that the user's head is fitted into the wearing portion 31, the wearing portion 31 having a certain elasticity of its own presses against a part of outer surface of the user's head portion so that the user can put on the wearing portion 31.

In addition, the third portion 30 further comprises a blocking portion 32 connected with the wearing portion 31 and for blocking sunrays directed to the user's face or skin. The blocking portion 32 is connected with the border of the wearing portion 31 and has a certain thickness and a certain area.

In case that the blocking portion 32 is prepared, when the user puts the wearing portion 31 on the user's head portion, sunrays directed to the user's face or skin can be blocked by this blocking portion 32.

Since the blocking portion 32 having a certain thickness and area blocks harmful rays applied to the user's face and skin by blocking sunrays directed to the user's face and skin, the user can listen to desired sounds without worries about his health.

Referring to the drawings, the blocking portion 32 is extended from the front side lower portion border of the wearing portion 31 to block sunrays directed to the user's face or skin.

Since the blocking portion 32 is for blocking sunrays directed to the user's face and skin, the same can be made of any materials that can block sunrays. That is, the blocking portion 32 can have a certain thickness and area to block sunrays or a film or some varnish that can block or reflect sunrays is applied on the outer surface of the blocking portions 32 to block sunrays.

In addition, it is also possible to make the blocking portion 32 of some materials that transmit visible rays and block only harmful rays out of direct sunrays to secure a clear view but block harmful rays.

Further, the blocking portion 32 extended from the wearing portion 31 can be fixed to the wearing portion 31 or can pivot on portions by which the blocking portion 32 is connected with the wearing portion 31. In the latter case, the user pivots the blocking portions 32 to cover entire face and protect the same from harmful rays.

The third portion 30 can comprise only the wearing portion 31 or can further comprise the blocking portion 32 extended from and connected with the wearing portion 31. For example of the case that the third portion 30 comprises only the wearing portion 31, bucket hats, beanies, cowl hats, etc. can be mentioned, for example of the case that the third portion 30 further comprises the blocking portion 32 extended from the border of the wearing portion 31, general hats, sun caps, fedoras, etc. can be mentioned, and for example of the case that a part of the outer surface of the user's head portion is fitted into the wearing portion 31, hair bands, ribs, crowns, headbands, etc. can be mentioned.

The third portion 30 comprises a supporting portion 33 for supporting at least the first portion 10. The supporting portion 33 can have a certain inner space to support the first portion 10 by receiving the same or the first portion 10 can be attached to the supporting portion 33 to be supported. Since the supporting portion 33 is for supporting the first portion 10, it does not matter where the supporting portion 33 is placed outside or inside the third portion 30 as long as the same can support the first portion 10.

In addition, the supporting portion 33 can be fixed to the third portion 30 or can selectively be detached from the third portion 30.

First, the case that the supporting portion 33 is placed inside the third portion 30 and the first portion 10 is received in the inner space of the supporting portion 33 will be described accompanying examples.

The third portion 30 comprises the supporting portion 33 for supporting at least the first portion 10. The supporting portion 33 having a certain inner space is fixed to the lower portion border inside the wearing portion 31 and the first portion 10 is received in the inner space of the supporting portion 33 so that the first portion 10 is supported by the third portion 30.

More particularly, the first portion 10 and the extensions 11 are received in the inner space of the supporting portion 33 so that the first portion 10 and the extensions 11 are supported by the third portion 30. Here, the supporting portion 33 can be formed to be possible to open the inner space or to be impossible to open it. When the inner space can be opened, it will advantageously be easy to replace, repair, and maintain the first portion 10 or other parts supported by the first portion 10.

Here, in the outside of the third portion 30, a sound system 80 for generating sounds that the user wants is placed. As a sound system 80, any devices that can provide sounds that the user wants are possible and considering weight and size, small MP3 players, small radios, or Bluetooth devices will be preferable.

The supporting portion 33 is formed to allow opening the inner space for supporting the first portion 10 fixed or detachable. The supporting portion 33 can comprise Velcro members, button members, or zipper members to fix or detach the first portion 10 and the supporting portion 33 can comprise any members as long as the members can make the first portion 10 possible to be fixed or detached.

Further, if the supporting portion 33 comprises a receiving space for receiving at least a part of the first portion 10, since the receiving portion can be opened by the user, removal of the first portion 10 outside the third portion 30 is possible.

On the outer surface of the third portion 30, a sound system supporting portion 81 can further be prepared. The sound system supporting portion 81 supports at least a part of the sound system 80 and restricts the movement of the sound system 80 to prevent the sound system 80 from getting out of the third portion 30.

The sound system supporting portion 81 can be formed in a form of pocket having a certain inner space. At least a part of the sound system 80 is kept in the inner space and provides sounds that the user wants. Here, since at least a part of the sound system 80 is kept in the inner space of the sound system supporting portion 81, the sound system 80 is fixed to the third portion 30 so that the shake of the sound system and its breakaway from the third portion 30 can be prevented.

The sound system supporting portion 81 can be formed on the first portion 10 or on the third portion 30. In addition, the same can be formed in a form of clip or safety pin that is fixed to the third portion 30 by clipping.

The case that the sound system 80 is supported by the first portion 10 will be described below making reference to FIG. 12 with examples. A part of outer surface of the third portion 30 is cut out and a part of the first portion 10 supported by the supporting portion 33 is exposed to the outside of the third portion 30. The sound system 80 is kept in this portion exposed to the outside of the third portion 30.

That is, two holes for exposure 34 having a form of slit and a certain distance between them are formed on a part of the third portion 30 and the first portion 10 passes through the exposure holes 34 so that a part of the first portion 10 sized as large as the distance between two holes is exposed to the outside of the third portion 30. The sound system 80 is detachably kept on the first portion 10 exposed to the outside of the third portion 30 as above.

Like this, at least two exposure holes 34 for exposing a certain part of the first portion 10 to the outside of the third portion 30 are formed on the third portion 30. The first portion 10 passing through one out of at least two exposure holes 34 is exposed to the outside of the third portion 30 and the same goes into the inside of the third portion 30 by passing through the other exposure hole so that the first portion 10 can be supported by the supporting portion 33 of the third portion 30.

Since at least a part of the first portion 10 is exposed to the outside of the third portion 30 with passing through the exposure holes 34, the first portion 10 is better supported by the third portion 30.

In addition, it is possible that the connecting line 70 comes out through one of the exposure holes 34 to the outside of the third portion 30 together with the exposure of the first portion 10. The connecting line 70 coming out through the exposure hole 34 to the outside of the third portion 30 is selectively connected with the sound system 80 and transfers sounds provided from the sound system 80 to the speakers 21.

On the other hand, as shown in FIG. 11, the third portion 30 also comprises penetration holes 35 providing some spaces through which the second portions 20 pass so that at least parts of the second portions 20 can be exposed to the outside of the third portion 30. The penetration holes 35 provide passages through which at least parts of the second portions 20 pass from the supporting portion 33. The second portions 20 passing through the penetration holes 35 are placed in the outside of the third portion 30 and extended toward the user's auditory organ.

Referring to FIG. 14, the first portion 10 can further comprise a fixing means 12 for fixing the first portion 10 to the blocking portion 32. The fixing means 12 is selectively connected with the supporting portion 33 comprised in the third portion 30 so that the first portion 10 can fixably or detachably connected with the third portion 30.

Here, the fixing means 12 and the supporting portion 33 formed with Velcro member are connected with each other so that the first portion 10 is fixably or detachably connected with the third portion 30 and it is also possible to form the fixing means 12 and the supporting portion 30 with other various members besides Velcro member such as button member, zipper member, coupling member, etc.

Only, it is common that the first portion 10 should be possible to be selectively fixed or detached with the third portion 30 regardless of forming members.

In addition, referring to FIG. 15, it is also possible to cut some parts of the third portion 30 for providing some spaces through which the second portions 20 pass. The second portions 20 passing through these cut portions can be exposed to the outside of the third portion 30 and extended toward the user's auditory organ.

The cut portions on the third portion 30 function as the penetration holes 35 and provide passages through which the second portions 20 pass. The second portions 20 passing through the penetration holes 35 formed on the third portion 30 direct toward the user's auditory organ.

When the second portions 20 pass through the penetration holes 35 formed on the third portion 30, the first portion 10 is placed on the outer surface of the third portion 30 and the second portions 20 are extended toward the user's auditory organ so that the speakers 21 can move near the user's auditory organ.

When the first portion 10 is placed on the outer surface of the third portion 30 and the speakers 21 are placed near the user's auditory organ, since the first and the second portions 10 and 20 are detachably connected with the third portion 30, the convenience of use is advantageously improved.

In addition, referring to FIG. 14 and FIG. 15, the third portion 30 further comprises a connecting line fixing portion 72 for fixing the end portion of the connecting line 70 connected with the sound system 80 on the outer surface or in the outer space. The connecting line fixing portion 72 is to fix the end portion of the connecting line 70 connected with the sound system 80.

This is to prevent the connecting line 70 from swinging by fixing the jack-typed end portion of the connecting line 70 which is coupled to the sound system in the connecting line fixing portion 72 when only the third portion 30 is used without the sound system 80 for charging the sound system or replacing the same with another one.

Since the connecting line 70 is prevented from swinging, potential inconvenience of use can advantageously be removed even when the sound system is not kept in the third portion 30.

Hereinafter, another form of the receiving set for individual according to the second embodiment of the present invention is described making reference to FIG. 16 to FIG. 21. FIG. 16 shows another form of the receiving set for individual according to the second embodiment of the present invention and FIG. 17 to FIG. 21 show another forms of the receiving set for individual according to the second embodiment of the present invention.

FIG. 16 shows a form that the third portion 30 comprises only the wearing portion 31. Referring to such a form, the wearing portion 31 is placed on the user's head portion, covers the user's head, and its lower portion is outwardly folded up.

Here, the penetration holes 35 are formed on the wearing portion 31 by cutting to make a certain space and when at least some parts of the second portions 20 pass through the penetration holes 35, at least some parts of the second portions 20 placed in the outside of the third portion 30 are extended toward the user's auditory organ.

Further, the sound system supporting portion 81 is not separately prepared but the sound system 80 is placed in the space formed when the lower portion of the third portion 30 is outwardly folded up. When the sound system 80 is kept in the space that the wearing portion 31 forms and the connecting line 70 exposed to the outside of the first portion 10 is coupled to the sound system 80, the sound system 80 is connected with the connecting line 70.

In case that the sound system supporting portion 81 is separately prepared, it is possible to form a certain space on the third portion 30 and keep the sound system 80 in this space.

In addition, the connecting portion 24 is prepared between the extensions 11 formed on the end portions of the first portion 10 and the connecting portion 24 can give fixing force preventing the first portion 10 from getting out of the third portion 30. The fixing force of the first portion 10 is further improved by the second portions 20 passing through the portions formed on the lower border portion of the wearing portion 31, that is, penetration holes 35.

It is certainly also possible that the supporting portion 33 for supporting the first portion 10 is prepared inside the wearing portion 31 and the first portion 10 is supported by the third portion 30.

On the other hand, referring to the connecting portion 24, it is possible that its one end portion is connected with one end portion in the horizontal direction of the first portion 10 and the other end portion is selectively connected with the other end portion in the horizontal direction of the first portion 10, or both end portions in the horizontal direction of the first portion respectively have connecting portions 24 and they are connected with each other.

That is, as long as the connecting portion 24 is placed between two end portions in the horizontal direction of the first portion 10 and is respectively connected with or integrated with the first portion 10 to generate fixing force around the user's head portion when the third portion 30 is placed on the user's head portion, any structures of connecting portion 24 will be possible.

The connecting portion 24 can be made of a material having its own elasticity. When the connecting portion 24 is made of a material having its own elasticity, both end portions of the connecting portion 24 are integrated with two end portions of the first portion 10 or connected with them, so the first portion's 10 fixing force against the third portion 30 is improved and the first portion 10 can easily be supported by the third portion 30.

For the connecting portion 24, any members such as button members, Velcro members, clip members, belt members, etc. can be used as long as they can generate fixing force when they are connected with each other.

Referring to FIG. 17 to FIG. 21, the third portion 30 has a form of hair band or headband. Referring to these, the third portion 30 is composed of only the wearing portion 31 and the first portion 10 is supported by this third portion 30 and the second portions 20 are extended toward the user's auditory organ.

Here, the first portion 10 further comprises the fixing means 12 for selectively being attached to or detached from the third portion 30. The fixing means 12 can be forms of loop-typed bands, protrusions, pins, etc. in order that the first portion 10 can be supported by the third portion 30 or the first portion 10 can be supported by the third portion 30 by the first portion's 10 and the third portion's 30 contact with each other.

Additionally, it is possible to adjust the positions of the speakers 21 at least some parts of which are supported by the second portions 20 by the third portion's 30 supporting the first portion 10.

In addition, the second portions 20 dispose portions of the speakers 21 from which sound signals are outputted to be directed toward and distanced from the user's auditory organ. That is, at least some parts of the speakers 21 are supported by the second portions 20 and the speakers 21 are disposed in the positions where the sound signal outputting portions of the speakers 21 are distanced from the user's auditory organ to make a certain space in between.

On the other hand, the second portions 20 can further comprise speaker grooves where at least some parts of the speakers 21 are held and several grooves like the above can be prepared in the longitudinal direction of the second portions 20 to allow adjusting the positions of the speakers 21.

Since the positions of the speakers 21 can be adjusted like this, the user can advantageously dispose the speakers 21 in the positions that he wants to listen to the sounds. This advantageously improves the convenience for users and the users' emotional dissatisfaction can advantageously be resolved.

Further, the sound system 80 for providing sounds that the user wants is placed on the first portion 10 and the sound system is supported by the sound system supporting portion 81.

The sound system supporting portion 81 can have a certain inner space where the sound system 80 can be received or the sound system 80 can be provided in the form of clip and supported by the sound system supporting portion 81.

That is, the sound system supporting portion 81 can be fixed to the first portion 10 and support the sound system 80 or can be detachably connected with the first portion 10 and support the sound system 80.

In addition, the first portion 10 further comprises a connecting line hole 71 through which the connecting line selectively coupled to the sound system 80 is exposed to the outside of the first portion 10 and the sound system supporting portion 81 is placed near the connecting line hole 71 to minimize the exposure of the connecting line 70 to the outside of the first portion 10.

In other words, as the connecting line hole 71, passage through which the connecting line 70 comes out to the outside of the first portion 10 and the sound system supporting portion 81 become closer, the length of the exposed part of the connecting line 70 is minimized. Accordingly, the connecting line 70 connected with the sound system 80 does not interrupt the user's face or arms and the inconvenience of the user's movement or act is removed to guarantee the user's activity and free movement.

Minimizing the connecting line 70 connected with the sound system 80 to minimize the connecting line 70 exposed to the outside by placing the connecting line 70 exposed to the outside of the first portion 10 on the upper portion than the speakers 21 and forming the connecting line hole 71 near the sound system supporting portion 81 guarantees the user's activity and free movement like wireless.

Further, the first portion 10 further comprises the connecting line fixing portion 72 for fixing the connecting line 70 exposed to the outside of the first portion 10 and even when the connecting line 70 is not coupled to the sound system 80, the connecting line 70 can be fixed. This prevents the connecting line 70 exposed to the outside of the first portion 10 from swinging and resolves the inconvenience of use.

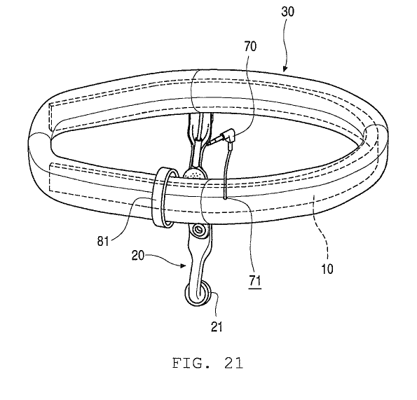

On the other hand, referring to FIG. 21, it is possible to place the first portion 10 inside the third portion 30 in the form of headband. Here as well, the third portion 30 comprises the penetration holes 35 having certain spaces through which the second portions 20 are exposed to the outside of the third portion 30 and the sound system supporting portion 81 for supporting the sound system 80.

The sound system supporting portion 81 is provided in the form of band having a certain elasticity or pocket and the sound system 80 is supported by the elasticity or the inner space.

In addition, the third portion 30 further comprises a hole through which the connecting line 70 projected to the outside of the first portion 10 comes out to the outside of the third portion 30 and the connecting line 70 exposed to the outside of the third portion 30 through this hole is selectively connected with the sound system 80 supported by the elasticity of the sound system supporting portion 81.

Here as well, the connecting line fixing portion 72 for fixing the connecting line 70 exposed to the outside of the third portion 30 is provided on the third portion 30 or the sound system supporting portion 81.

Only, when the connecting line 70 is fixed by the elasticity of the sound system supporting portion 81, it is possible that the sound system supporting portion 81 does the function of the connecting line fixing portion 72.

According to the receiving set for individual according to the above-mentioned embodiments of the present invention, the user can hear sounds from outside and listen to sounds transferred from the sound system at the same time since the user's auditory organ is opened, so the user can rapidly handle dangerous situations of outside and the safety of the user is considerably increased.

In addition, since the sound system is kept in the third portion 30 placed on the user's head portion, the connecting line connected with the sound system is minimized and the connecting line exposed to the outside is also minimized, so there is no connecting line interrupting the user's face or arms like wireless sound system in spite of one with wire. This can guarantee the user's activity and free movement.

Since the speakers for outputting sound signals can easily move their positions, the user can dispose the speakers in the positions that he wants without inserting the speakers into the user's auditory organ, so the user can listen to sounds with his auditory organ open. This can considerably improve the convenience of use and the activity and the safety of user.

Since the speakers are disposed in the positions distanced from the user's auditory organ, the user can listen to sounds without damaging his auditory organ. This can remove the user's worries about health due to the use of the receiving set.

Accordingly, it can be said that the receiving set for individual according to the embodiments of the present invention has great availability in the sound industry and the industry for outdoor activities.

1. A receiving set for individual comprising a first unit placed on user's head portion and
second units supported by said first unit and disposing speakers in the positions distanced from the user's auditory organ.

2. A receiving set for individual according to claim 1, wherein said first unit is placed along the outer surface of the user's head portion.

3. A receiving set for individual according to claim 1, wherein said second units change their positions in comparison with said first unit.

4. A receiving set for individual according to claim 1, wherein said first unit is integrated with said second units.

5. A receiving set for individual according to claim 1, wherein said second units comprise:
linking portions connected with said first portion and
combining portions connected with said linking portions to be possible to change their positions, accordingly to adjust the speakers positions as well.

6. A receiving set for individual according to claim 5, wherein said linking portions are connected with the first unit to be possible to change their positions.

7. A receiving set for individual according to claim 1, wherein said second units comprise:
linking portions rotatably connected with the first unit and
combining portions connected with said linking portions to allow translational movement, accordingly the adjustment of the speakers' positions.

8. A receiving set for individual according to claim 1, wherein said second units connected with said first unit can adjust the speakers' positions by their own elasticity.

9. A receiving set for individual according to claim 8, wherein said second units are connected with the first unit to be possible to change their positions.

10. A receiving set for individual according to claim 1, wherein said second units comprise:
linking portion connected with said first unit and
combining portions guided by said linking portions to be possible to adjust said speakers' positions.

11. A receiving set for individual according to claim 10, wherein said second units are connected with the first unit to be possible to change their positions.

12. A receiving set for individual according to claim 1, wherein said second units comprise:
linking portion connected with said first unit and
combining portion detachably connected with said linking portions to allow adjusting said speakers' positions.

13. A receiving set for individual according to claim 12, wherein said linking portions are connected with the first unit to be possible to change their positions.

14. A receiving set for individual according to claim 1, wherein said first unit or said second units further comprise an application apparatus supporting portion for supporting application apparatuses for supplementary functions.

15. A receiving set for individual according to claim 14, wherein said first unit or said second units further comprise an application apparatus connecting line connected with said application apparatus.

16. A receiving set for individual according to claim 1, wherein said first unit comprises a connecting jack coupled to the sound system for providing sounds and a connecting line for transferring to said speakers.

17. A receiving set for individual according to claim 16, wherein said connecting jack is fixed to said first unit, selectively connected with said sound system, and supports said sound system to transfer sounds.

18. A receiving set for individual comprising
a first portion positioned on the user's head portion;
second portions extended from said first portion toward the user's auditory organ, connected with said first portion to be possible to change their positions, and disposing the speakers in the positions where the user's auditory organ is opened toward sounds from outside; and
a third portion worn on the user's head portion and supporting said first portion.

19. A receiving set for individual according to claim 18, wherein said first portion and said second portions comprise a connecting line for connecting the sound system and said speakers.

20. A receiving set for individual according to claim 18, wherein said third portion comprises a wearing portion kept on the user's head portion.

21. A receiving set for individual according to claim 20, wherein said third portion further comprises a blocking portion connected with said wearing portion and blocking sunrays.

22. A receiving set for individual according to claim 20, wherein said third portion is a hair band that the user wears on his head portion.

23. A receiving set for individual according to claim 18, wherein said third portion comprises a supporting portion for supporting at least said first portion.

24. A receiving set for individual according to claim 23, wherein said supporting portion is placed on the outer surface or inner surface of said second portions.

25. A receiving set for individual according to claim 18, wherein said third portion comprises penetration holes through which at least some parts of said second portions pass so that said speakers can be exposed toward the user's auditory organ.

26. A receiving set for individual according to claim 19, wherein said third portion further comprises a connecting line fixing portion for fixing said connecting line connected with said sound system.

27. A receiving set for individual according to claim 18, wherein said third portion comprises an exposure hole for exposing at least some part of said first portion and said first portion is supported by the supporting portion prepared in said third portion while passing through said exposure hole.

28. A receiving set for individual according to claim 18, wherein said third portion further comprises a sound system supporting portion where the sound system for providing sounds is detachably held.

29. A receiving set for individual according to claim 18, wherein at least said third portion comprises a supporting portion for fixably or detachably supporting at least some part of said first portion.

30. A receiving set for individual according to claim 29, wherein said supporting portion is formed with Velcro member or button member.

31. A receiving set for individual according to claim 29, wherein said supporting portion can open the inner space.

32. A receiving set for individual comprising
a first member having its own elasticity;
second members extended from said first member toward the user's auditory organ;
a third member at least some part of which is supported by said first member and placed on the user's head portion;
fourth members supported by said second members and disposing the portions of said speakers from which sounds are outputted to be directed toward the user's auditory organ and to make certain spaces between those portions and the user's auditory organ; and
a connecting line some part of which is supported by said first member and said fourth members and transferring provided sounds to said speakers.

33. A receiving set for individual according to claim 32, wherein said first member comprises extensions extended, in horizontal direction, from the portions where said first member is connected with said second members.

34. A receiving set for individual according to claim 33, wherein said first member is integrated with said extensions.

35. A receiving set for individual according to claim 33, wherein one end portion of said extensions is fixed to one end portion of said first member and the other end portion of said extensions is selectively coupled to the other end portion of said first member.

36. A receiving set for individual according to claim 32, wherein said second members are connected with said first member to be possible to change their positions.

37. A receiving set for individual according to claim 32, wherein said fourth member are connected with said second members to be possible to change their positions.

38. A receiving set for individual according to claim 32, wherein said third member comprises penetrations holes for providing passages through which at least said fourth members come out to the outside of said third member.
